(19) United States
(12) Patent Application Publication
(10) Pub. No.: US 2010/0251661 A1
(43) Pub. Date: Oct. 7, 2010

(54) STRUCTURAL FIXING SYSTEM WITH HIGH CLAMPING FORCE AND TIGHTENING PRECISION WITH HIGH CORROSION RESISTANCE

(75) Inventors: Karl Heinz Illgner, Kaarst (DE); Federico Vescovini, Monfalcone (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: Societa' Bulloneria Europea S.B.E.S.P.A., Monfalcone (IT)

(21) Appl. No.: 12/666,972

(22) PCT Filed: Jun. 4, 2007
(86) PCT No.: PCT/IT07/00387

§ 371 Date: Jun. 4, 2010

(51) Int. Cl. E04B 1/38; F16B 35/00; F16B 37/14; G06K 19/07

(52) U.S. Cl. 52/698; 411/383; 411/372.5; 235/492

(57) ABSTRACT

A structural fixing system with high clamping force, tightening precision and high corrosion resistance, in particular for light and heavy metalwork elements, comprises a flanged metal bolt (10), and/or a flanged metal nut (20), obtained by hot or cold forming. In the space between the base of the flange (12) and the shank (13) of the bolt (10) or below the flange of the nut (20) is a precision collar with a smaller diameter than the diameter of the flange.

### SUBJECT OF THE INVENTION

This invention refers to a structural fixing system with high clamping force and tightening precision with high corrosion resistance. More specifically, the invention refers to a structural fixing system designed to be used when high clamping force and tightening precision is necessary in hostile environments or environments potentially subject to corrosion, be they internal or external.

This system foresees a series of particularly advantageous embodiments for joining light and heavy metalwork elements in the sector of constructions of considerable size such as, for example, offshore marine platforms, ships, metal towers, for example relative to wind energy production plants, bridges, stadiums, buildings, for example skyscrapers, etc.

### BACKGROUND ART

The solution classically adopted for joining light and heavy metalwork elements in the construction industry consists of a bolt and a nut, interposing a pair of washers that rest on the respective outer surfaces of the elements to be joined.

The fasteners, washers and nuts that are used for the purposes described above are normally made from alloyed heat treated steel if high-level mechanical characteristics are required, and subsequently hot dip galvanized in order to form a surface layer that is as resistant as possible to corrosion. For special applications, the washers used are also subjected to additional hardening to allow, for example, S235 or S355 steel elements, or in any case generally with very low material mechanical characteristics, to be joined.

The bolts, washers and nuts which are used for the purposes described above, are also made from stainless steel if high-level mechanical characteristics are not required for the bolts, nuts and washers.

In regard to stainless steel bolts, nuts and washers, they can only be used when particularly heavy mechanical characteristics are not required. For example the maximum tensile strength of this stainless steel kit are only 600 N/mm² compared to a high tensile kit on the other hand that can reach a tensile strength around 1.000 N/mm². It is, however, possible to use stainless steel bolts, nuts and washers to join light or heavy metalwork elements, increasing the number of fixing points but also increasing the costs of the fixing system which is already much higher compared to heat treated bolts, nuts and washers with anticorrosion surface treatment. It has, nevertheless, been demonstrated that applications involving the use of stainless steel products are subject to serious problems of oxidation with the risk of cracking that can only be limited by enriching the steel with alloys such as, for example, molybdenum or chrome.

On the other hand, to get corrosion resistance for high mechanical resistance fasteners, the thickness of the hot dip galvanized layers is generally at least 50 microns, with values that cannot however be estimated with precision and which can vary considerably, reaching 80 microns in some cases.

Having fasteners with this corrosion protection by hot dip galvanisation the thickness cannot be precisely foreseen. The hot dip galvanization process gives at the time of production a series problems and disadvantages, as this has a considerable effect on assembly precision and the necessary pre-loading force of the fasteners.

In addition, with the aim of maintaining the threading tolerances of the nut-bolt assembling after the coating operation, it is necessary to reduce the bolt thread diameters when assembled with a standard threaded nut or, vice versa, to maintain a standard bolt thread diameter and increase the nut thread diameter.

If the thread diameter of the bolt is reduced, the stressed area of the bolt is lower and therefore also the mechanical clamping loads are smaller than standard threaded fasteners.

In particular, if the mating areas of the bolt and nut threads are reduced the clamping loads of the fasteners may reach only values which are lower than for fasteners with standard tolerances of the threads.

The difference in hardness of the bolt and nut with respect to the layer of zinc should also be considered. It has been technically demonstrated that this hardness difference (approximately 300 HV) represents an important cause of loading loss. The presence of this softer corrosion resistant layer between the bolt thread and the nut thread gives rise to a loss of clamping force. This problem becomes even more serious in the presence of high stress levels, such as for example the vibrations of a wind tower or an offshore structure, causing dangerous losses of clamping forces in the fixed fasteners.

Furthermore, when used for fixing light and heavy metalwork elements, galvanised bolts and nuts present another problem, caused by the zinc-plating process, whether by electroplating or hot dip galvanising, of favouring hydrogen embrittlement. This hydrogen embrittlement causes cracks in the pre-stressed fasteners.

Another problem of hot dip galvanized, not negligible from a metallurgical point of view particularly for bolts, is the formation of inter-granular cracks or micro-cracks caused by the surface penetration of the zinc into the matrix of the base metal. This problem can cause cracks particularly in the under-head radius and the thread of the bolts.

Moreover, the surface of the hot dip galvanized bolts has a very high friction coefficient, and it is necessary to perform a second operation of the product, particularly the nuts, to lubricate the surface of the threads to optimize, as far as possible, the friction between the bolt and the nut.

In addition, hot dip galvanised bolts may present another problem. This process is normally done in zinc baths at temperature up to 560° C. and this favours the loss of the mechanical characteristics of heat treated high tensile bolts. The heat treatment of the bolts is normally done between 430° C. and 530° C. It is evident that the zinc bath temperature is a critical limit. If the immersion time in the zinc bath particularly for big bolts is accidentally increased by a few minutes or if problems should occur with setting the temperature of the bath the risk to loose the mechanical characteristic is high.

In the event of problems with the hot dip galvanized process, the bolts cannot be reprocessed.

In particular, for bolts with a large diameter, the high temperature of the zinc baths creates a further problem of cracks under the head. Due to the big temperature difference between zinc bath and the core of the bolt it is possible to have a thermal shock that causes cracks under the head.

In any case it would be useful to have bolts and nuts for assembling light and heavy metalwork elements that have a greater torque tension precision compared to known solutions and which allow precise calculation of the pre-loading force and can withstand higher loads than known solutions with the same external dimensions.

The solutions known to the background art, which foresee the presence of a bolt, a nut and two washers for each assembling point of light or heavy metalwork elements, involve additional problems and disadvantages.

For example, when it is needed to assemble one bolt, one nut and two washer for one assembling point it is needed to consider the purchasing stage, the storage and availability of the correct quantity of products according to the quantity of assembling points. This will represent a considerable amount of costs.

Furthermore, at the time of assembly, usually carried out manually in difficult working environments (for example, at a considerable height), the need to insert a washer on the shank of the bolt and a second washer on the side of the nut, makes the assembly considerably more complicated and exposes the worker to a series of notable safety risks.

Finally, assembly precision is always problematic since there are invariably irregularities between the surface of the washer and the bolt/nut. This may compromise the possibility of precisely pre-loading forces of each assembling point. Due to this problem and the above mentioned loss of clamping forces due to the hot dip zinc galvanized layer on the threads between the bolt and the nut, it is necessary to carry out careful annual checks on the clamping forces of each assembled kit in order to limit as far as possible the dangerous losses of clamping force. These checks obviously increase the costs of service and maintenance of plants in which this type of fasteners are used.

Fitting a washer both on the bolt side and on the nut side also presents the problem of external deformation of the washer (bending) due to a size difference between the outer diameter of the washer (larger) and the contact area surface of the bolt and the nut on the washer (smaller). As a result of this size difference, in addition to the difference in mechanical characteristics, it is not possible to achieve uniform load distribution, thus creating a bending effect on the outer diameter of the washer.

It is well known that there are bolts and nuts with an integrated flange.

This flange has the same purpose as the washer, and these bolts and nuts are in fact used without washers for assembling, in particular, for metal components in the production for example of motor vehicles and their components.

The use of such flanged bolts and nuts is not known in the construction industry of light and heavy metalwork elements as described above.

The fact that there are no known applications of flanged fasteners and nuts for the connection of light and heavy metalwork elements must be ascribed to various factors.

One factor of primary importance is that flanged fasteners and nuts are usually obtained by means of a hot or cold forming process that cannot achieve limited tolerances on the dimension of the flange.

The fasteners and nuts obtained by means of these production processes are subject to dimensional variations caused by the process itself. Limited tolerances can only be achieved through costly processes, such as for example trimming in the case of the cold process or the second machining operation in the case of hot processing.

Since the assembling of light and heavy metalwork elements requires considerable assembly precision and pre-loading forces as constant as possible, flanged fasteners and nuts are not good enough for this use.

In particular, it should be noted that the most common standards give big tolerances for the flange dimensions, which are in direct contact with the elements to be fixed.

The use of standard flanged bolts and nuts could not be recommended for assembling light and heavy metalwork elements.

Nevertheless, the use of flanged bolts for assembling light and heavy metalwork elements would be advantageous if it would be possible to eliminate all the disadvantages caused by the use of washers. The biggest disadvantages are the differences of the materials between the bolts and washers and between the nuts and washers, and the lower pressure on the fixing point surface.

Concerning the use of stainless steel flanged bolts and nuts, it must be noted that these are not currently used, since their mechanical strength does not allow high strength applications. The manufacture of such flanged bolts and nuts also causes the problem of tolerances of the flanges as described above.

Today kits consisting of a bolt, a nut and two washers is not completely satisfying even if they are used in most applications for assembling light and heavy metalwork elements.

Today the mentioned system with hot dip galvanized surfaces normally is used in the sector of assembling light and heavy metalwork elements in corrosive environments and often exposed to the joint action of different forces of nature such as wind, rain, acid rain, solar radiation, at times salt water, sea water, etc.

Experience has shown that, for applications of this type, the known assembling systems based on hot dip galvanised elements are insufficient to ensure adequate protection against corrosion, as moisture, salt water and acids can penetrate the various assembled interfaces between the elements of the fixing system (bolt head/washer, washer/metalwork element, washer/nut) and the interface between the metalwork elements which are joined together.

To prevent corrosion, sophisticated procedures have been done over the years for a periodic control and maintenance of the connecting points. It is necessary to judge weak points and replace corroded elements long before a structural safety problem arises.

In practical terms, these procedures are complex and costly from the point of view of time, materials and labour.

In other cases, the use of stainless steel fasteners, nuts and washers is preferred, increasing the number of fixing kits but also the costs, making this solution appropriate only for a very limited number of cases.

The need therefore exists for a high resistance fixing system for light and heavy metalwork elements in order to reduce the number of fixing points and which is mechanically reliable and with high clamping force, tightening precision, requiring very little maintenance and providing adequate protection against corrosion.

### DESCRIPTION OF THE INVENTION

This invention proposes to provide a fixing system for light and heavy metalwork elements which makes it possible for rigid connections of these elements combined with conditions that ensure constant and repeatable pre-loading forces. This is provided with technical factors which ensures very strong resistance to corrosion, so that the system in question is practically immune to external corrosion.

According to a first aspect of the invention, this system comprises a flanged bolt with the features described in claim 1.

In accordance with a second aspect of the invention, this system comprises a flanged nut with the features described in claim 9.

According to a third aspect of the invention, this system comprises a fixing kit for light and heavy metalwork elements with the features described in claim 17.

The dependent claims describe particularly advantageous embodiments of the system according to the invention.

In accordance with a first embodiment, the system according to this invention comprises a flanged metal bolt, obtained by means of cold or hot forming.

This bolt consists of a generally hexagonal-shaped head, which widens at its base to form a circular flange. The bolt also comprises a threaded shank forming the actual fixing element.

According to an important feature of the invention, the space between the base of the flange and the shank of the bolt is equipped with a precision collar with a smaller diameter than the diameter of the flange.

The precision collar described above is obtained during the forming operations, for example cold forming on a multi-station press, at a stage in which it is possible to achieve very limited dimensional tolerances.

If it is necessary to produce the bolt by means of hot forming and limited tolerances of the collar cannot be achieved, then a subsequent machining operation must be carried out to provide the collar with exact dimensional values.

It is thus possible to produce flanged fasteners with a precision collar that has a surface in contact with the light and heavy metalwork element to be connected, which is extremely precise from the point of view of dimensional tolerances.

It is in this way possible to use flanged fasteners to connect light and heavy metalwork elements, since thanks to the dimensional accuracy of the collar and constant friction coefficient a constant pre-loading force can be maintained, not possible with traditional flanged fasteners.

This precision collar has a further important support function in another embodiment of the invention, in particular where the presence of a peripheral seal made from substantially elastic material is foreseen, being press-fitted and thus positioned below the outer edge of the bolt flange.

A second embodiment of the invention consists of a flanged metal nut obtained by means of cold or hot forming.

This nut consists of a generally hexagonal-shaped head, which widens at its base to form a circular flange. The nut also comprises a longitudinal internally threaded through hole forming the actual fixing element.

According to an important feature of the invention, as in the case of the flanged bolt, the space below the base of the flange is equipped with a precision collar with a smaller diameter than the diameter of the flange.

All the considerations described above relative to the dimensional precision of the collar, gives the possibility of using the flanged nut according to this invention also for fixing light and heavy metalwork elements, apply to this case too.

Similar to the case of the flanged bolt, according to another embodiment of the invention the precision collar has a further important support function for a peripheral seal made from substantially elastic material which is press-fitted and thus positioned below the outer edge of the nut flange.

According to another important feature of the invention, the flanged bolt and/or flanged nut as described above can be subjected to anticorrosion surface treatment giving an anticorrosion layer on the surface of the bolt and/or nut with max 20 microns thickness.

This anticorrosion layer can, for example, be obtained by means of a preliminary treatment of flanged fasteners and nuts with zinc flake; this treatment, generally carried out by spraying (or by immersion or centrifugation), forms a protective layer of zinc and aluminium flake that provide the fasteners and nuts with cathodic protection.

This basecoat is then covered with a topcoat which can consist of organic-based liquid paint (usually epoxy-resin-based) or inorganic-based paint (in this case silicate-based).

The aims of this second coat are to provide a mechanical protective barrier against corrosion and to reduce the friction coefficient (self-lubricating effect).

After application of the topcoat, the bolts and nuts are placed inside a furnace to harden the coatings at a temperature never exceeding 250° C.

This anticorrosion layer provides a series of advantages with respect to known solutions, that is to say with respect to hot dip galvanized.

First of all, as the thickness of the coating is much thinner than the layer formed by hot dip galvanising (20 microns max compared to 50-80 microns) it is possible to use the threading completely without having to reduce the bolt thread or increase the nut thread, that would reduces the clamping forces.

In addition, the thickness can be determined with greater precision compared to the hot dip galvanized thickness, making it possible to calculate the pre-load forces with great precision to get higher clamping forces.

Moreover, the anticorrosion layer has a much lower friction coefficient that can be obtained with hot dip galvanizing. This anticorrosion layer is self-lubricating, making it possible to avoid the lubricating treatment that hot dip galvanized nuts are always subjected, thus saving time and costs and improving the performance of the kit.

This treatment also insures, right from the start, the absence of hydrogen embrittlement.

In addition, the hardness of the surface treatment is considerably greater than can be obtained with hot dip galvanized fasteners. So no losses of clamping forces will be possible as a result of low hardness of the zinc layer typical of hot dip galvanized products. Therefore one of the main reasons for the periodic check of the tightening values of the fixing points after their installation has been eliminated.

Finally, the fact that the soaking fixing temperature of the coating is low, and in particular always lower than 250° C., makes it possible to obtain further positive effects, such as avoiding thermal shock in large bolts during hot dip galvanising, and thus avoiding cracks. We also prevent any loss of the mechanical features previously provided by the processing of the bolts.

In particular, this treatment can be organic, non-organic, neutral, coloured or without additional sealant. All this contributes to provide the system according to the invention with greater flexibility of use in respect to known systems.

According to the invention, this anticorrosion surface treatment can be of various types, depending on the needed requirements.

According to a particularly advantageous embodiment of the invention, the seal positioned below the flange of the bolt or nut comprises assembling means for a protective anticorrosion cap, generally made from synthetic material, providing total protection of the head of the bolt or the body of the nut.

When present, this cap provides the system with a total degree of protection against corrosion, preventing the attack of any external agent against the bolt and/or nut. Such an embodiment appears highly appropriate for applications in extremely corrosive environments such as marine type application even not exposed to immersion or in direct contact with running water.

### DESCRIPTION OF THE DRAWINGS

Other advantages of the invention will become clear on reading the description below of some embodiments of the invention, given as non-binding examples, with the help of the accompanying drawings, in which:

FIG. 1 shows a schematic side view of a bolt belonging to a fixing system with high clamping force, tightening precision and anticorrosion features according to this invention, without the seal;

FIG. 2 shows a schematic side view partially in cross-section of a nut belonging to a fixing system with high clamping force, tightening precision and anticorrosion features according to this invention, without the seal;

FIG. 3 shows a schematic side view of a fixing system with high clamping force, tightening precision and anticorrosion features according to this invention as used to fix light and heavy metalwork elements;

FIG. 4 shows a schematic side view of a particular alternative application of the anticorrosion system according to the invention.

### DESCRIPTION OF SOME EMBODIMENTS

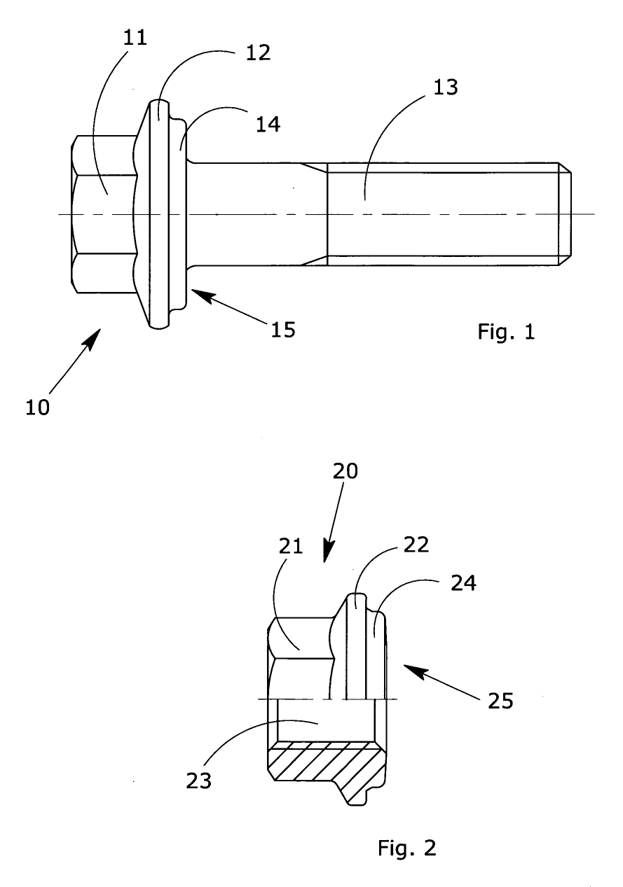

In FIG. 1, the reference number 10 indicates in general a flanged bolt as part of a fixing system according to this invention.

The flanged bolt 10 comprises a hexagonal shaped head 11 from which a generally circular flange 12 extends; the bolt 10 also comprises a threaded shank 13.

According to the invention, a precision collar 14 is formed, during the preferably cold forming of the bolt 10, between the upper part of the shank 13 and the lower part of the flange 12.

As mentioned above, the precision collar 14 can be obtained with limited dimensional tolerances and can therefore have constant dimensions within very precise limits. This means that the lower surface 15 of the collar, which is the portion of the bolt 10 which comes into direct contact with the light or heavy metalwork element to be connected, presents absolutely constant dimensions. It can therefore be efficiently used for applications requiring high assembly and connection precision, relative to constant friction coefficients and pre-load forces like those described in this patent application. In this context it is appropriate to note that it would be theoretically possible to produce flanged fasteners (which, we repeat, have wide dimensional tolerances at the level of the flange) with more limited dimensional tolerances with respect to those foreseen by current regulations.

However, the cold forming process should in this case be supplemented, as regards the flange, by a further trimming operation to cut the flange to size, with a consequent considerable increase in bolt production costs.

If the fasteners are hot formed, than there must be a supplement second procedure by a machining operation on the flange, with a consequent considerable increase in bolt production costs.

In practical terms, the operation would therefore be uneconomical.

On the other hand, for the flanged bolt according to this invention, the precision collar can be formed directly during the forming process with considerable dimensional accuracy thus reaching the predefined close tolerances, since the collar is pressed during the stage following the creation of the flange.

In FIG. 2, a flanged nut 20 belonging to the fixing system according to the invention comprises a hexagonal shaped head 21 and a circular flange 22 which extends from the base of the head. The flanged nut 20 comprises a longitudinal hole 23 with internal thread.

Similarly to what is described with reference to the bolt 10 in FIG. 1, the nut 20 presents a precision collar 24 at the base of the flange 22, preferably obtained by means of cold forming, advantageously using a multi-station press.

The same considerations described above in the case of the bolt 10 apply here too, relative to the relationship between the dimensional tolerance (wide) of the flange 22 and the dimensional tolerance (very limited) of the precision collar 24.

In the case of the flanged nut 20 according to the invention, the surface 25 of the collar 24 which comes into contact with the light or heavy metalwork element to be connected has absolutely precise dimensions.

When obtaining a constant friction coefficient precise pre-loading forces necessary for connecting light or heavy metalwork elements can be guaranteed.

The precision collar 14, 24 described above and illustrated with reference to FIGS. 1 and 2 has another important function. More specifically, it supports and fixes in position an anticorrosion seal or O-ring which, by means of its position between the lower surface of the flange and the surface of the metalwork element to be connected, actively prevents any passage of external agents, moisture, steam, water, etc. Inside the connection zone, drastically improving the anticorrosion seal with respect to the traditional known solutions comprising a bolt, nut and two washers.

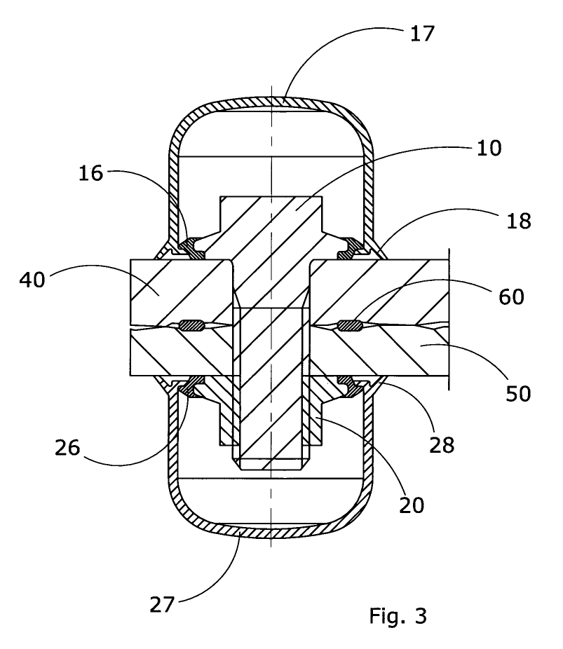

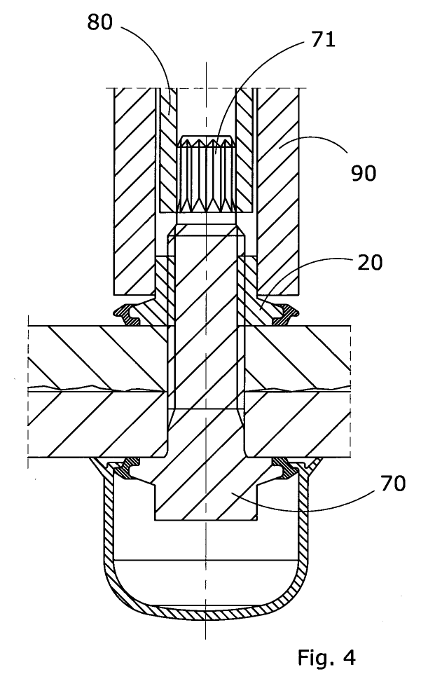

An example of what is described above is shown in FIG. 3, where the presence can be noted of a connection between two light or heavy metalwork elements 40, 50 made by means of an anticorrosion system according to this invention.

In particular, in the case shown in FIG. 3 the flanged bolt 10 and the flanged nut 20 are each equipped with a respective seal 16, 26 designed to prevent the passage of external agents towards the connection zone.

Moreover, in the embodiment shown in FIG. 3, the anticorrosion system according to the invention foresees the use of an additional protective element, consisting of a pair of caps 17, 27 generally made from synthetic material, which snap into the respective seals 16, 26.

The structure of the caps is such that, in this embodiment, they comprise a tab 18, 28 which rests on the metalwork elements 40, 50 forming a further barrier to the passage of corrosive agents.

Obviously, as can be seen in the figure, the caps completely cover both the head of the bolt 10 and the nut 20, creating a highly efficient and long-lasting anticorrosion protection.

Again with reference to FIG. 3, the anticorrosion system is completed by an additional sealing ring 60, obtained by various methods (for example by means of a chemical sealing resin or a synthetic elastic element) and positioned in the interface between the metalwork elements 40, 50 to be connected, around the area where the flanged bolt 10 and flanged nut 20 are located.

This sealing ring 60 is applied in cases in which the construction tolerances and the type of materials to be applied make it necessary.

An anticorrosion protection of the type illustrated in FIG. 3 is extremely reliable and efficient in highly corrosive environments such as, for example, in off-shore platforms.

The invention is described above with reference to some preferred embodiments, where the connections are made using traditional type flanged bolts and flanged nuts.

The anticorrosion system according to the invention can obviously be used with a wide variety of connection types.

By way of example, FIG. 4 shows a non-traditional connection, which can be used in particular in places that are difficult to access where the fixing system can be tightened on only one side of the connection.

In the case in question, a special flanged bolt 70 is used and which, at the end of its shank, is fitted with a component 71 with several points (12 for example) for rapid and efficient tightening of the bolt from the point side by means of a special tool 80. In this case, the tightening movement is carried out by turning the flanged nut 20 by means of a rotating tool with a bolting head 90.

The tightening operations can be considerably simplified, greatly reducing the costs for checking the tightening of these fixing kits during maintenance operations.

It can be noted that in this embodiment, the bolt 70 is fitted with a cap, while a further cap will be fitted on the flanged nut 20, once tightening by means of the tool 80 and 90 is complete.

In this case too, as seen previously, both the bolt and the nut are fitted with integral seals.

In the case described above, the cap is anchored directly on the seal. Additional embodiments are, however, foreseen in which the cap is anchored on the flange of the bolt and/or nut.

Other types of connections that can be used by means of this invention are:
fixing by means of connection of a bolt in a blind hole;
fixing by means of connection of a nut on a stud bolted into a blind hole;
fixing by means of connection between two nuts on a through stud with double threads.
other fixing forms of just a bolt or just a nut with threaded bodies made from various types of steel as required.

Finally, the bolts and nuts according to the invention can be embedded with microchips, in particular RFID microchips, which allow extremely accurate management of stocks and of the fasteners and kits after assembly.

This and other variations are possible within the framework of technical equivalents.

1. A structural fixing system with high clamping force, tightening precision and high corrosion resistance, in particular for light and heavy metalwork elements, comprising a flanged metal bolt, obtained by means of cold or hot foaming, comprising of a head, which widens at its base to form a generally circular flange, and a threaded shank forming the actual fixing element, including in the space between the base of the flange and the shank of the bolt is a precision collar (14) with a smaller diameter than the diameter of the flange.

2. A system according to claim 1, wherein the bolt comprises an anticorrosion surface coating with a reduced thickness not normally more than 20 microns.

3. A system according to claim 2, wherein the surface coating consists of a basecoat obtained by means of zinc flake treatment and an organic or inorganic self-lubricating topcoat.

4. A system according to claim 1 also comprising a seal positioned between the base of the flange and the side surface of the precision collar.

5. A system according to claim 4, wherein the seal is made from synthetic or natural resilient material.

6. A system according to claim 1 also comprising a cap protecting the head of the bolt, this cap being anchored to the flange or to the seal.

7. A system according to claim 1 wherein it also comprising a microchip associated with the bolt.

8. A system according to claim 7, wherein the microchip is the RFID type or similar.

9. A structural fixing system with high clamping force, tightening precision and high corrosion resistance, in particular for light and heavy metalwork elements, comprising a flanged metal nut, obtained by means of cold or hot forming, comprising a head which widens at its base to form a generally circular flange, and an internally threaded through or blind longitudinal hole, forming the actual fixing element, including in the space below the base of the flange of the flanged nut a precision collar with a smaller diameter than the diameter of the flange.

10. A system according to claim 9, wherein the nut comprises an anticorrosion surface coating with a reduced thickness not normally more than 20 microns.

11. A system according to claim 10, wherein the surface coating includes a basecoat obtained by means of zinc flake treatment and an organic or inorganic self-lubricating topcoat.

12. A system according to claim 9 comprising a seal positioned between the base of the flange and the side surface of the precision collar.

13. A system according to claim 12, wherein the seal is made from synthetic or natural resilient material.

14. A system according to claim 9 including a cap protecting the head of the bolt, this cap being anchored to the flange or to the seal.

15. A system according to claim 9 including a microchip associated with the nut.

16. A system according to claim 15, wherein the microchip is the RFID type or similar.

17. A kit for the structural fixing with high clamping force, tightening precision and high corrosion resistance of light and heavy metalwork elements, in particular for elements of marine offshore platforms, ships, metal towers, plants for the production of wind energy, bridges, stadiums, buildings, skyscrapers, comprising at least one flanged bolt according to claim 1.

18. A kit for the structural fixing with high clamping force, tightening precision and high corrosion resistance of light and heavy metalwork elements, in particular for elements selected from the group of marine offshore platforms, ships, metal towers, plants for the production of wind energy, bridges, stadiums, buildings, skyscrapers, comprising at a flanged nut according to claim 9.

19. A list as claimed in claim 17 including a flanged unit, obtained by means of cold or hot forming, comprising a head which widens at its base to form a generally circular flange, and an internally threaded through or blind longitudinal hole, forming the actual fixing element, included in the space below the base of the flange of the flanged nut a precision collar with a smaller diameter than the diameter of the flange.
